(19) United States
(12) Patent Application Publication
(10) Pub. No.: US 2024/0353299 A1
(43) Pub. Date: Oct. 24, 2024

(54) SOFT MATERIALS THAT ABSORB IMPACT

(71) Applicant: University of Maryland, College Park, College Park, MD (US)

(72) Inventors: Srinivasa R. Raghavan, Columbia, MD (US); Sairam Ganesh, Manassas, VA (US); Sai Nikhil Subraveti, College Park, MD (US)

(21) Appl. No.: 18/640,988

(22) Filed: Apr. 19, 2024

Related U.S. Application Data
(60) Provisional application No. 63/497,023, filed on Apr. 19, 2023.

(51) Int. Cl. G01N 3/303; C08L 5/04; C08L 51/10; C08L 89/00; G01N 3/06

(52) U.S. Cl. CPC G01N 3/303; C08L 5/04; C08L 51/10; C08L 89/00; G01N 3/068

(57) ABSTRACT

Hydrogels are networks of polymer chains that are swollen in water. These gels can protect vulnerable objects (e.g., an egg or a fruit) if wrapped there around. Gels are constructed by either physical cross-linking (e.g., gelatin) or chemical cross-linking (e.g., acrylamide). The addition of starch granules to the above gels greatly enhances their protective abilities. When a load strikes a gelatin gel containing 20% starch, the peak impact force is reduced by 25% when compared to a bare gel without the starch. Correspondingly, the coefficient of restitution (COR) is also lowered by the presence of starch (e.g., a ball bounces less on a starch-bearing gel). The impact-absorbing effects of starch granules are correlated to their ability to shear-thicken water. When starch granules are gelatinized by heat, they no longer give rise to shear-thickening, and in turn, their protective ability in a gel is also eliminated.

### CROSS REFERENCE TO RELATED APPLICATIONS

This application claims priority under 35 U.S.C. § 119 to provisional patent application U.S. Ser. No. 63/497,023, filed Apr. 19, 2023, titled “Flexible Hydrogels that Absorb Impact”. The provisional patent application is herein incorporated by reference in its entirety, including without limitation, the specification, claims, and abstract, as well as any figures, tables, appendices, or drawings thereof.

### TECHNICAL FIELD

The present disclosure relates generally to a hydrogel and/or corresponding methods and manufacture. More particularly, but not exclusively, the present disclosure relates to a flexible hydrogel comprising additives that enhance the hydrogel's protective capabilities.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Hydrogels are networks of polymer chains that are swollen in water. In recent years, several routes have been devised to make hydrogels that are flexible and bendable. Yet, no known bare hydrogels are protective, and the addition of nanoparticles like iron oxide or silica do not help.

Numerous objects in everyday life are fragile, brittle, deformable, crushable, or otherwise vulnerable to impact(s) (collectively: “vulnerable objects”).

Thus, there exists a need in the art for flexible hydrogels which reduce impact force to object, lower the coefficient of restitution (COR) of an object, and/or otherwise enhance the protective capabilities of the hydrogel.

### SUMMARY

Brittle and fragile objects include those made of glass or some plastics, several food items (especially eggs), expensive products, specialty products, and high-tech products. These products can also include smartphones, phone cases, boat fenders, car fenders, aircrafts, spacecraft landing structures, supports/joints, infant car seat liners, and floor mats. Brittle and fragile objects can crack or shatter if dropped onto a hard surface. Crushable and deformable objects include many food products, including most fruits and vegetables. If these crushable and deformable objects are dropped onto a hard surface, they are damaged beyond repair. When vulnerable objects are transported over large distances (from manufacturing sites to warehouses and then to stores), they must reach their destination undamaged. Online shopping has led to consumers expecting that packages can be delivered intact to their front doors. This underscores the need for packaging materials to protect fragile goods. Commercially available lightweight packaging materials are too bulky. Some examples of these commercially available lightweight packaging materials include foam core boards, packing peanuts, and bubble wrap. None of these commercially available lightweight packaging materials are biodegradable.

Other soft commercially available impact-absorbers include Sorbothane® (see e.g., U.S. Pat. No. 4,808,469, titled “Energy absorbing polyurethane composite article”) and D3O® (U.S. Pat. No. 5,037,189, titled “Energy absorbing material”). These materials are made from synthetic polymers, are expensive, and their mechanism of action is not well understood.

Polymer hydrogels are water-swollen materials formed by cross-linking polymer chains through either physical or chemical bonds. A gel of gelatin (e.g., the gelatin sold under the brand name Jell-O®) is an example of a physical gel. The protein chains in this gel are connected by physical cross-links into a network. Chemical gels are formed by the free-radical polymerization of water-soluble monomers such as acrylamide (AAm), and in this case, the polymer chains are connected by chemical (covalent) bonds at cross-linking junctions. There has been a long-standing interest in making gels that are flexible, stretchable, and tough.

The present inventors have previously synthesized gels that can be stretched more than 10 times their original length before breaking. See e.g., Cipriano et al., “Superabsorbent Hydrogels that are Robust and Highly Stretchable.” Macromolecules 2014, 47, 4445-4452, which is hereby incorporated by reference in its entirety herein. See also Gharazi et al., “Nature-Inspired Hydrogels with Soft and Stiff Zones that Exhibit a 100-fold Difference in Elastic Modulus.” ACS Appl. Mater. Interfaces 2018, 10, 34664-34673, which is hereby incorporated by reference in its entirety herein.

A popular class of tough and flexible hydrogels are the “double-network” gels that contain two coexisting networks, e.g., a covalent one of AAm and a physical one of alginate cross-linked by calcium (Ca²⁺) cations.

On the two well-accepted measures of impact absorption, i.e., the coefficient of restitution (COR) and the peak-force ratio (PFR), the values for our starch-bearing soft films will be lower (indicating better impact-absorption) than D3O® and Sorbothane®.

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to protect objects and living beings from impact(s). For example, the protective abilities of starch can be imparted to biopolymers (such as gelatin and alginate), synthetic polymers (such as polyacrylates, which are used in diapers; polyvinyl alcohol (PVA); or polylactic acid (PLA)), and as well as biopolymers made using nanoparticles from natural sources (e.g., cellulose nanofibers (CNFs)).

It is a further object, feature, and/or advantage of the present disclosure to provide impact-absorbing materials which demonstrate superiority over known, commercial counterparts, such as foam core boards, packing peanuts, and bubble wrap. The coefficient of restitution (COR) and the peak-force ratio (PFR) of the starch-bearing soft films described herein are lower (indicating better impact-absorption) than D3O® and Sorbothane®. On practical tests that involve protecting fragile objects, such as eggs or small fruit like blueberries, the starch-bearing soft materials protect vulnerable objects better than D3O® and Sorbothane®.

It is a further object, feature, and/or advantage of the present disclosure to impart an impact-absorbing ability to biopolymer-based plastic substitutes, such as hydrogels.

It is a further object, feature, and/or advantage of the present disclosure to improve the impact resistance of polymers with shear thickening additives.

It is a further object, feature, and/or advantage of the present disclosure to combine porous polymers and starch granules to make impact-absorbers that are also lightweight. The hydrogels described herein can be made more porous by introducing gas bubbles (foam) into the polymer synthesis. The resulting sheets are fluffier, weigh less, and are more flexible. With starch granules introduced into these sheets to make them impact-absorbent, these materials are both extremely strong and lightweight. The weight of our impact-absorbent soft materials is therefore much more controllable, by even 90% or more. Starch-containing films (dry gels) are excellent impact-absorbing properties, as are starch-containing bioplastic films with low COR and PFR.

It is still yet a further object, feature, and/or advantage of the present disclosure to determine which gels are better than others at impact absorption, and further, to determine what distinguishing features said gels have.

It is still yet a further object, feature, and/or advantage of the present disclosure to analyze differences reflected in the rheology of gels.

It is still yet a further object, feature, and/or advantage of the present disclosure to determine whether it is better for a gel to be elastic or viscoelastic.

It is still yet a further object, feature, and/or advantage of the present disclosure to engineer films of bioplastics can be engineered to have similar tensile strength and Young's modulus to films of commercial plastics used in packaging, and to endow these bioplastics with impact-absorbing properties through the addition of starch granules. Such bioplastics are biodegradable and compostable, unlike any of the current materials used for packaging (e.g., bubble wrap) or impact-absorption (e.g., shoe insoles).

It is still yet a further object, feature, and/or advantage of the present disclosure to alter the rheology and/or structure of the gels and thereby enhance their ability to absorb impact, based on an understanding of how said rheology and/or structure of the gels affects the hydrogel's ability to absorb impact(s). Starch granules enhance the ability of gels to absorb impact because gels generally display clastic rheology, i.e., their elastic modulus G′ far exceeds their viscous modulus G″. Nevertheless, they do have some viscoelasticity and we find that starch granules enhance the viscous (dampening) character of the gels. This is reflected in a higher loss tangent tan δ, which is the ratio of G′/G″. Starch granules are known for their ability to shear-thicken water. Shear-thickening is a property associated with flowing suspensions, whereas in a gel, starch granules are expected to be immobilized within the polymer network. Nevertheless, we show that if the shear-thickening of starch in water is eliminated by heat-induced gelatinization, so are the impact-absorbing abilities of the starch-bearing gel.

While typical gels, including the well-known strong ones such as the double-network gels, on their own fail to protect against impact, the present inventors have made a striking discover that starch granules greatly enhance the ability of gels to absorb impact.

The hydrogels disclosed herein can be used in a wide variety of applications. For example, flexible hydrogels that can absorb impact can be used in the design and implementation of protective coatings or armor for vulnerable objects, which may include without limitation the sports, defense, and consumer sectors. Additionally, the advantageous structural advantages conferred by using impact improving additives is shown to work with both physical gels (e.g., gelatin) as well as chemical gels (e.g., AAm).

It is preferred the hydrogels are safe to use, cost effective, and durable. For example, the ideal gel should be thin, flexible, and strong. The gel should be able to be wrapped around a vulnerable object of (any) arbitrary shape without the gel tearing or breaking. Such a strong gel should be easily synthesizable in the lab from inexpensive precursors. Even better, the gel should be biocompatible and biodegradable. The impact-absorption capabilities of the gels can endure over a wide temperature range—from −30° C. to 80° C. The difference gel's protective capabilities are ideally negligible regardless of whether the gel is fully hydrated or substantially dehydrated.

Methods can be practiced which facilitate use, synthesis, manufacture, assembly, maintenance, and repair of hydrogels which accomplish some or all of the previously stated objectives.

The hydrogels can be incorporated into systems and kits which accomplish some or all of the previously stated objectives.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIGS. 1A-1C pose central questions that are answered by the present disclosure. A brittle material such as the egg shown in FIG. 1A, is covered by a thin, flexible hydrogel, as shown in FIG. 1B. The wrapped gel protects the egg such that the egg can withstand impact onto a hard surface, as shown in FIG. 1C. The gels can be further improved if they are modified to contain starch particles.

FIGS. 2A-2C show a classification of gels tested in the present disclosure. FIG. 2A shows a first category is physical gels having noncovalent cross-links, including gels of gelatin and agarose. FIG. 2B shows the next category is chemical gels with covalent cross-links. The chemical gels can be made by polymerizing acrylamide (AAm), either with bis-acrylamide (BIS) or laponite (LAP) nanoparticles. FIG. 2C shows the last category is double-network gels, which can have both an alginate-Ca²⁺ and an AAm-BIS network. Gels of agarose and AAm-BIS are brittle and were not analyed further. Most of the analysis of the present disclosure relates to gelatin gels.

FIGS. 3A-3B show structures of the gels described in the present disclosure. FIG. 3A shows the control gel that is based on gelatin. The gelatin nanostructure comprises chains intertwined into triple helices at cross-linking junctions. The gel is optically clear. FIG. 3B shows the addition of starch granules to a gelatin gel that makes the gel turbid. The gel still retains flexibility, and the gel can be folded or wrapped around a vulnerable object like an egg.

FIGS. 4A-4B show optical micrographs of starch granules and gels with starch. FIG. 4A shows 10% starch granules suspended in water, with a detailed view appearing to the right. Most of the granules are near-spherical or elongated spheres, and their size ranges from 10 to 30 μm. FIG. 4B shows 10% starch granules in a 10% gelatin gel. A thin section of the gel was cut and examined under the microscope. The starch granules can still be seen in the gel.

FIGS. 5A-5B shows a schematic (front-elevation view) and a perspective view of the load cell setup used to study impact absorption by various gels. A mass is dropped through the plastic tube from a drop height H onto the sample placed on the impact plate, and the load sensor measures the force vs time.

FIG. 6 shows force F vs time t plots as a load makes impact with gels of gelatin with and without starch. The load has a mass of 50 g and the mass is dropped from a height of 20 cm onto the various gels at t=0. Each gel has a thickness of 4 mm. The reduction in the peak height (Fₚₑₐₖ) in the F(t) plots reflects impact absorption by the gels.

FIGS. 7A-7C show effects of different variables on impact absorption by gels. In each plot, the peak force Fₚₑₐₖ recorded from the F(t) traces during impact experiments is plotted. FIG. 7A show a 50 g mass dropped on gels of different thicknesses; FIG. 7B shows a higher mass of 100 g dropped on gels of different thicknesses; and FIG. 7C shows a mass of 50 g dropped on gels from different heights. Error bars represent standard deviations.

FIGS. 8A-8B show force F vs. time t plots for impact of a load on conventional gels with varying compositions. The load has a mass of 50 g and it is dropped from 20 cm onto 4-mm gels at t=0. FIG. 8A plots results gelatin gels with 10% and 20% gelatin concentrations. The control concentration used in each example is 10% gelatin. Increasing the gelatin to 20% has minimal effects on F(t), and moreover, as shown by FIG. 8C, the 20% gelatin gel is brittle. FIG. 8B shows AAm gels with varying polymer (AAm) and crosslinker (BIS) concentrations, along with the control. The F(t) curves are negligibly changed in these cases. The gel with higher (2×) AAm is still flexible, but with higher (3×) BIS, the gel becomes brittle, as seen from the photos, as shown in FIG. 8D.

FIGS. 9A-9B show coefficient of restitution (COR) for a marble dropped on various gels. FIG. 9A shows a schematic of the experiment. The marble is dropped onto 4 mm thick gels from a drop height dh, and the bounce height bh to which it rebounds is measured and used to calculate the COR. The hard benchtop surface (without a gel) serves as the control.

FIG. 9B shows a bar graph of the results for 10% gelatin gels containing various amounts of starch. The bars correspond to the mean COR values, while the error bars are standard deviations. Results for p values from significance testing of various data pairs by the Student's t test are also shown.

FIGS. 10A-10B show measures impact absorption. FIG. 10A shows results from a marble being dropped from a drop height H and the bounce height h to which it rebounds gives the COR. A gel with starch has a much lower COR than a control gel, showing its ability to absorb impact. FIG. 10B shows a weight that is dropped on a gel and the force F is measured vs. time 1. From the peak force, the peak force ratio (PFR) is calculated. A gel with starch has a much lower PFR than a control gel, indicating its ability to absorb impact.

FIGS. 11A-11C show dynamic rheology of gelatin-starch gels. Results are shown for a 10% gelatin gel (FIG. 11A) and the same with 10% starch (FIG. 11B) and 20% starch (FIG. 11C). In each case, the elastic modulus G′ and the viscous modulus G″ are plotted as functions of the frequency ω. The gap between G′ and G″ decreases with increasing starch (as shown by the arrows), indicating that the loss tangent tan δ increases with starch content.

FIG. 12 shows force F vs time t plots for impact of a load on acrylamide (AAm) gels with and without starch. The load has a mass of 50 g and it is dropped from 20 cm onto 4 mm gels at t=0. The peak height (Fₚₑₐₖ) is lowered for the gel containing 10% starch, indicating impact absorption. The latter is then heated to 70° C. to gelatinize the starch, cooled back to room temperature, and retested. In this case, the F(t) curve and the Fₚₑₐₖ value revert to those of the original gel.

FIGS. 13A-13C show steady-shear rheology of starch suspensions before and after gelatinization. In all cases the apparent viscosity is plotted as a function of shear-rate. FIG. 13A shows that initially, the starch suspensions show shear-thickening, i.e., an increase in viscosity over a range of shear-rates. The samples are flowing liquids, as shown by Photo 1.

FIG. 13B shows samples that are then heated to 70° C. to gelatinize the starch, cooled back to room temperature, and retested. Now, they are gel-like pastes with a yield stress, as shown by Photo 2. The rheology now indicates shear-thinning, i.e., a decrease in viscosity with shear-rate. The plot of FIG. 13C compares the rheology of the 30% starch sample before and after gelatinization.

FIG. 14 shows the coefficient of restitution (COR) for a marble dropped on AAm and AAm-starch gels. The marble is dropped onto gels (4-mm thick) from a height H, and the height h to which it rebounds is measured and used to calculate the COR (see FIGS. 9A-9B). The hard benchtop surface (without a gel) serves as the control. Results are for 10% AAm gels with and without 10% starch. The latter is then heated to 70° C. to gelatinize the starch, cooled back to room temperature, and retested. The bars correspond to the mean COR values while the error bars are standard deviations. Results for p values from significance-testing of various data-pairs by the Student's t-test are also shown.

FIGS. 15A-15B show dynamic rheology of an AAm-starch gel before and after gelatinization. The gel has 10% AAm and 10% starch. FIG. 15A shows results from the initial rheology. FIG. 15B shows results from the gel being heated to 70° C. to gelatinize the starch, cooled back to room temperature, and retested. In each case, the clastic modulus G′ and the viscous modulus G″ are plotted as functions of the frequency ω. The gap between G′ and G″ is higher in FIG. 15B as shown by the arrows, indicating that the loss tangent tan δ is decreased.

FIGS. 16A-16B test the ability of gels to protect eggs. An egg is wrapped in a flexible gel and dropped in free fall onto a hard surface from a height of 40 cm (15 in). FIG. 16A shows that when the gel is 10% gelatin, the egg is broken by the impact. FIG. 16B shows that when the gel is 10% gelatin+10% starch, the egg remains intact.

FIGS. 17A-17G test the ability of gels to protect blueberries. FIG. 17A shows the setup involves a blueberry encased by two gel strips (“ravioli” design). A weight of 50 g is then dropped onto the covered blueberry from a height of 20 cm. FIGS. 17B-17G illustrate the blueberry before impact, at the moment of impact, and after impact. FIGS. 17B-17D show that when the gel is 10% gelatin, the blueberry is crushed by the impact. FIGS. 17E-17G shows that when the gel is 10% gelatin+10% starch, the blueberry remains intact.

FIG. 18A shows a dry film composed of gelatin and 30% starch. FIG. 18B shows the coefficient of restitution (COR) of a marble dropped on various gels (wet) or films (dry).

FIGS. 19A-19C show the clastic modulus G′ and the viscous modulus G″ from dynamic rheology are plotted as functions of the frequency ω. The gap between G′ and G″ (as shown by the arrows), indicates the loss tangent tan δ.

FIGS. 20A-20C show results from uniaxial compression on tissues, gels, and films for each of animal tissues (FIG. 20A), wet gels (FIG. 20B), and dry films (FIG. 20C). In each case, the sample is first compressed (loading curve, up arrow) and then relaxed (unloading curve, down arrow). Many samples show a ‘hysteresis-loop’ and the area of this loop signifies the extent to which the material absorbs impact.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

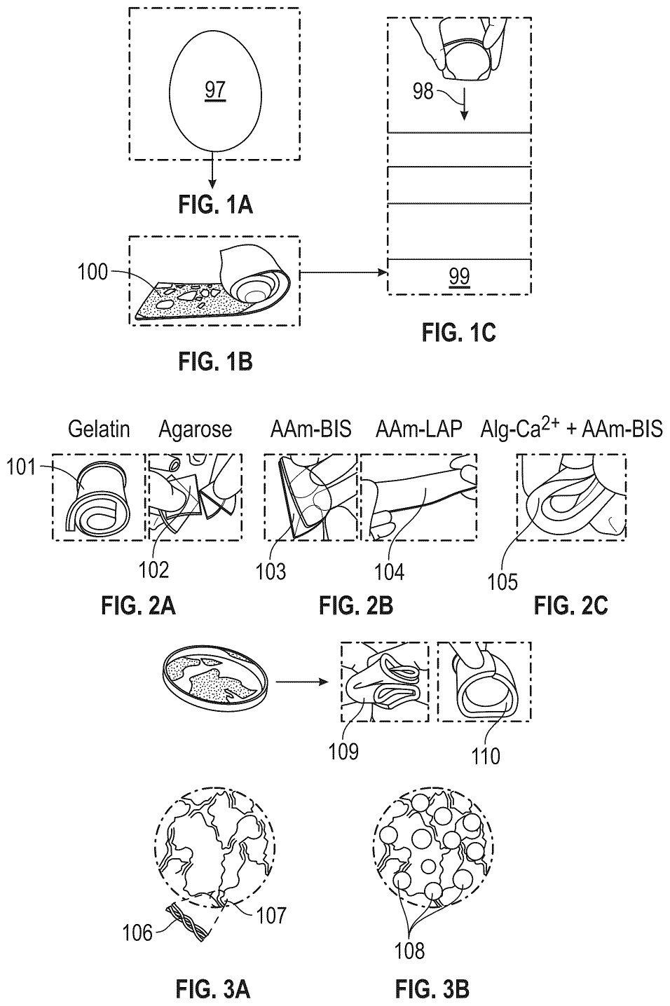

The present disclosure addresses several problems in the art that are depicted by FIGS. 1A-1C. A flexible gel can protect a vulnerable object. As a prototype for a vulnerable object, FIG. 1A shows a vulnerable object 97, which in this instance is a fresh egg with a long dimension around 3-5 cm, and a thin, brittle shell. If this egg is dropped from a height of about 30 centimeters (˜1 foot), a force 98 (i.e. Earth's gravitational force) will cause the vulnerable object 97 to collide with a hard surface 99 such as the ground or a tabletop, and the shell of the egg will crack.

A soft impact-absorbing material 100, which in this instance is a hydrogel, is 2-5 mm thick and flexible enough for it to be wrapped around the egg, as shown in FIG. 1B. This gel-covered egg can be dropped onto the hard surface 99 from the same height and the egg can withstand the impact, as shown in FIG. 1C.

Finally, a heavy object can be dropped onto the gel-covered egg (or hit it with a heavy object such as a hammer), and the egg can remain intact.

The above technical problems and solutions have practical relevance and importance in many industries. Specifically, there is a need to protect people (especially their heads and joints) from hard impact. For example, players in American football wear helmets to protect against the violent impacts they suffer during play. Despite the helmet requirement, there has been an increase in the frequency of concussions suffered by these players in recent years. Football players are also increasingly at risk for brain damage or the early onset of neurodegenerative diseases. Use of impact-absorbing materials can improve helmet designs to protect these players. Other wearable objects that can be improved by the impact-absorbing materials such as motorcycle jackets, prosthetics, body armor liner, shoe inserts, glove padding, and steel toe shoes.

In a specific example, there are many applications for the impact-absorbing materials described herein for purposes of cushioning (e.g., in shoes, athletic gear, and prosthetic sleeves). Said cushioning can reduce injuries and/or provide comfort, such as while walking or running. Often times existing, cushioning products have names such as gel, foam, or rubber, even if this is not technically correct. They are generally just materials that provide the user with a ‘cushioning’ effect, i.e., they feel soft and pliable.

Commercially available insoles that employ these products are bulky or unfashionable because they are externally visible. Moreover, many do not substantially reduce impact. The hydrogels described herein can thus satisfy a need for insoles and other cushioning products that are thinner, lighter, and more comfortable, while also being invisible or nearly invisible.

Soft sleeves made of a gel or silicone rubber are often worn over a prosthetic. While commercially available sleeves provide some comfort, they do not appear to absorb impact. Thus, an impact-absorbent gel sleeve comprising that utilizes the protective hydrogels described herein will be both beneficial to the user and more affordable.

Protective equipment for athletes includes helmets, shoulder pads, knee pads, etc. Many of the pads are soft materials made from foam, gel, or rubber. Helmets are a category of their own because they have a hard exterior shell with additional padding inside. Both helmets and pads have to be thick to offer protection, and this thickness limits the mobility of the athlete. We have contacted Under Armour and discussed with their scientist, Dr. Matt Trexler. As noted in the support letter from Dr. Trexler, Under Armour is very interested in impact-absorbing materials and they work with the commercial product D3O®. If our impact-absorbing gel is proven to be superior to D3O® (which is a key goal of this MII project), they would be very interested. A gel that works better could be used to make thinner and lighter pads, which would increase comfort and mobility for the athlete. Our gel will also be much cheaper than the competition.

Apart from humans, there is also a need to protect soft, fragile, or brittle goods, both natural and man-made, as they are transported and/or shipped from one place to another place or during everyday use. For example, fruits and vegetables have to be protected from breaking or being crushed during transport. Another example of a vulnerable object 97 is the smartphone. In this regard, a smartphone case is an example of a protective material. The case has to be as thin as possible while still structurally robust enough to protect an expensive device.

The impact-absorbing materials described herein can also be used as dampeners so as to reduce the effects of vibration(s). Starch-based impact absorbing materials can be employed as dampeners in earplugs, in sound insulation, and in tool coatings.

A few recent papers do exist on impact-absorbing materials, which include elastomers and foams, but none of these studies have dealt with hydrogels. There are also commercial products such as D3O® and Sorbothane® that claim to be effective at absorbing impact, but their composition or their underlying scientific basis cannot be found in the academic literature. Regardless of material type, there is little systematic guidance from the literature on how to improve the impact-absorbing ability of a given material. Hydrogels are a model class of soft materials to analyze in the context of impact absorption. The science behind hydrogels is well-established, and the properties of gels can be easily varied in the lab. Hydrogels are also important to analyze because they offer insight into biological systems. In biology, impact absorption is associated with soft, gel-like tissues like the cartilage and with the spine. In the case of the spine, the spinal or intervertebral discs (IVDs) are gel-like with a soft core and a stiffer shell. These discs are responsible for absorbing shock on the spine arising from different activities such as walking, sitting, or running.

The focus of the present disclosure is therefore on hydrogels and their ability to absorb impact and thereby protect underlying objects. FIGS. 2A-2C show a classification of gels tested in the present disclosure. FIG. 2A shows a first category is physical gels having noncovalent cross-links, including physical flexible gels 101 (e.g., a gelatin gel) and brittle flexible gels 102 (an agarose gel). FIG. 2B shows the next category is chemical gels with covalent cross-links. The chemical gels can be made into chemical brittle gels 103 (e.g., by polymerizing acrylamide (AAm) with bis-acrylamide (BIS) nanoparticles) and into chemical flexible gels 104 (e.g., by polymerizing acrylamide (AAm) laponite (LAP) nanoparticles). FIG. 2C shows the last category is double-network gels 105, which have both an alginate-Ca²⁺ and an AAm-BIS network. The brittle gels 102, 103 agarose and AAm-BIS are brittle were not analyzed further. The other gels are flexible gels 101, 104, 105. Most of the studies are done with gelatin gels.

Gelatin and AAm starch-bearing gels are flexible and strong and can be easily wrapped around a vulnerable object of arbitrary shape. Both gels are synthesized easily in the lab from readily available and cheap precursors. In addition, the gelatin-starch gel is both biocompatible and biodegradable.

A load cell was custom built to compare the impact absorption of various gels. Two measurable parameters are identified from the data that correlate with superior impact absorption. The best impact-absorbing gels are confirmed to be able to protect vulnerable objects such as eggs and fruit (e.g., blueberries) against hard impact. The hydrogels of the present disclosure can thus be very advantageous if used to protect vulnerable objects during transport and can thus have very positive impacts on the packaging and/or shipping industries. Hydrogels could be dehydrated (dried) and reduced in size so that they can be stored for later re-use. This could have serious implications for improving shipping processes and for the shipping industry.

To determine whether flexible hydrogels could protect vulnerable objects, and as models for vulnerable objects, the following examples were focused on: (a) standard chicken eggs (long dimension 3-5 cm), which have a thin, brittle shell; (b) mini or “grape” tomatoes (1-2 cm); and (c) blueberries (1 cm or less).

The tomatoes and blueberries got crushed if a heavy weight (50 g or higher) was dropped directly on them. The eggs cracked if dropped in free fall from a height of about 30 cm (1 foot) or higher.

Various figures included in the present disclosure show a flexible gel wrapped around the vulnerable objects can protect them from damage under the above conditions because the gel itself is both flexible and strong: i.e., (i) the gel is strong enough to not break or tear under the impact of a heavy weight; and (ii) the gel is flexible and pliable enough to remain intact when wrapped around a fragile or brittle object with an arbitrary shape.

A number of gels were analyzed with the above criteria in mind, including both physical gels (where the cross-links are physical, i.e., noncovalent bonds, such as hydrogen bonds or ionic bonds) and chemical gels (where the cross-links are covalent bonds). The tested gels are listed in FIGS. 2A-2C. Gels of gelatin (typical concentration 10%) were flexible and strong. A thin strip of this gel could be folded or rolled up (see e.g., flexible physical gel 101 that includes gelatin). Gelatin gels are thus the main focus of the rest of the present disclosure and are further discussed with specific reference to FIGS. 3A-3B. Conversely, gels of the polysaccharide agarose were stiff, but not flexible or strong. Specifically, a 5% agarose gel, made in the form of a rectangular strip, would break into pieces if we tried to fold the strip (see e.g., the brittle physical gel 102 that includes agarose). Thus, because agarose gels cannot be wrapped around an object such as an egg, they appear unsuitable for protecting vulnerable objects.

Chemical gels of AAm cross-linked with a multifunctional monomer, i.e., N,N′-methylene-bis-(acrylamide) (BIS). An AAm-BIS gel previously disclosed by a present inventor comprises 10% AAm and 0.34% BIS. See Banik et al., “New Approach for Creating Polymer Hydrogels with Regions of Distinct Chemical, Mechanical, and Optical Properties.” Macromolecules 2012, 45, 5712-5717, which is hereby incorporated by reference in its entirety herein. However, such AAm-BIS gels are brittle and do not withstand bending or twisting (see e.g., brittle chemical gel 103 that includes acrylamide (AAm) polymerized with bis-acrylamide (BIS) nanoparticles).

Another chemical gel previously disclosed by a present inventor is a gel of 10% AAm cross-linked by 2% laponite (LAP) particles. See id. This is also a chemical gel, with the LAP particles acting as multifunctional cross-linkers for AAm chains. See Gharazi et al., supra. The AAm-LAP gel is flexible and strong, and can be stretched to more than ten (10) times its original length without breaking (see e.g., the flexible chemical gel 104 that includes acrylamide (AAm) polymerized with laponite (LAP) nanoparticles). On the basis of these studies, the AAm-LAP gels were suitable for potentially forming the foundation of an impact absorbing gel, but not the AAm-BIS gels.

Additionally, a well-known class of flexible and tough gels were prepared, namely, the double-network (DN) gels. The DN gel has two interpenetrating networks, of which one is a chemical network of AAm-BIS while the other is a physical network of alginate (an anionic polysaccharide) cross-linked by calcium (Ca²⁺) cations. This gel was prepared by combining 10% AAm and 1% Alg, polymerizing with 0.006% BIS, and then incubating in a bath of 2% Ca²⁺ for 24 h. The Alg-AAm DN gel is tough and flexible, as expected (the double-network gel 105 that includes both a alginate-Ca²⁺ and an AAm-BIS network).

Although gels of gelatin, AAm-LAP, and the Alg-AAm DN are flexible and strong, they are unable to protect vulnerable objects on their own. Even if the polymer concentration (gelatin in the former and AAm, BIS in the latter), the results remain the same. It was then determined whether additives such as nanoparticles or microparticles enhance the protective abilities of gels. Two kinds of particles were tested in a gelatin matrix: iron-oxide (Fe₂O₃) and carbon black (CB). Gelatin gels with up to 5% Fe₂O₃ or 10% CB remained flexible and reasonably robust; however, their ability to protect vulnerable objects remained poor, e.g., the results were indistinguishable from the respective bare gels without particles.

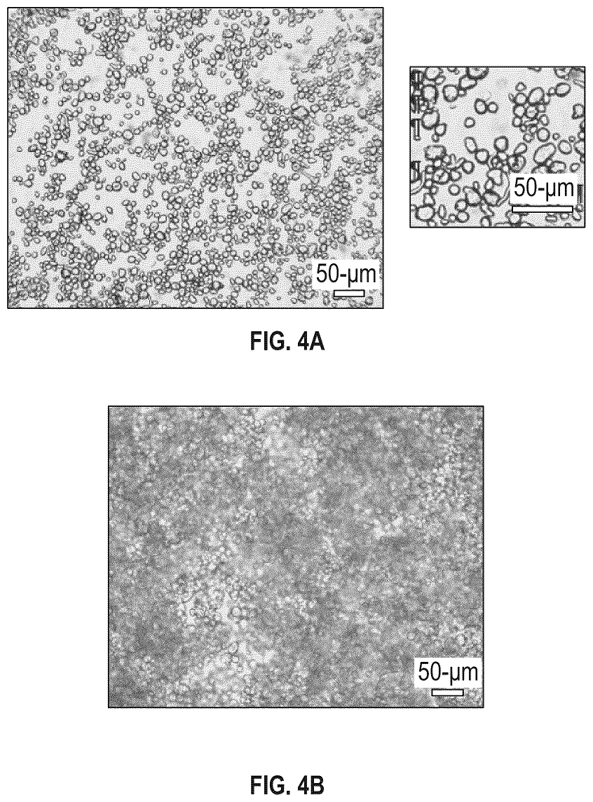

Starch granules as an additive were then tested. These particles enhance the protective abilities of both gelatin and AAm gels. FIGS. 3A-3B depict the gelatin-starch system. The matrix is typically 10% gelatin in water, which forms a clear gel (FIG. 3A). Gelatin is the denatured form of the protein collagen. When a hot gelatin solution is cooled, the protein chains 106 come together to form triple-helical junctions 107 with their neighbors, as shown in the schematic. To make a gelatin-starch gel, 10% of starch granules 108 (sourced from corn) can be added to the hot solution of 10% gelatin and then cool the mixture to room temperature. The starch granules have sizes from 10 to 30 μm, as shown by the optical micrograph in FIG. 4. The composite gelatin-starch gel remains strong, yet flexible (FIG. 3B). The gel can be turbid and can have a white color due to light-scattering from the starch granules. FIG. 3B shows that this gel can be bent and folded, and the gel can be easily wrapped around a vulnerable object such as an egg.

### Gelatin-Starch Gels: Load Cell Experiments

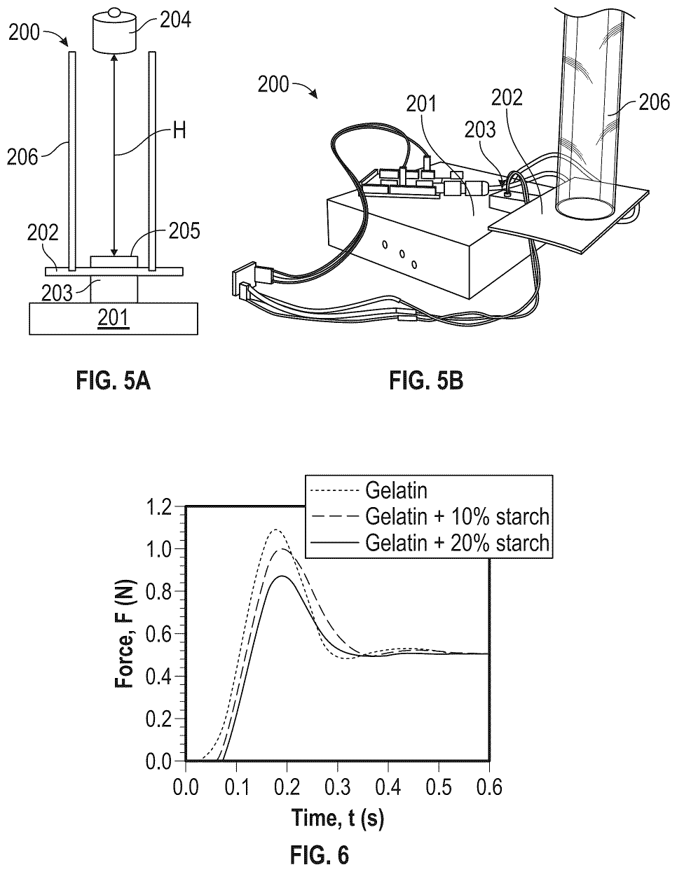

The effect of starch on gelatin gels was quantified using a load cell 200, the setup of which is shown in FIGS. 5A-5B. A base plate 201 (a 5 cm thick block of wood) is attached to an impact plate 202 (a 1 mm thick plastic), which in turn is connected to a load sensor 203. A mass 204 is dropped from rest onto a gel sample 205 (a disc of 6 cm diameter and varying thickness) placed on the impact plate 202, and the impact force detected by the load sensor 203 is recorded as a function of time. The hollow transparent plastic tube 206 allows the mass 204 to travel along a precise vertical trajectory before the mass 204 contacts the gel sample 205. For the data shown in FIG. 6, we use gels of a thickness (e.g., 4 mm) and drop the mass 204 (e.g., 50 gram-mass) onto the sample gel 205 from a drop height dh (e.g., 20 cm).

The plots in FIG. 6 are for the force F recorded by the load sensor as a function of time/following impact. Each curve shows a peak and then levels off at the same steady-state value of F=0.5. N (corresponding to 50 g). In the case of a 10% gelatin gel, F increases to 1.1 N at its peak, which is when the mass makes contact with the gel. The mass then bounces off the gel, and thereby, F decreases beyond the peak. The mass then hits the gel a second time and this is manifested as a small second peak in the force. Thereafter, the mass stabilizes and settles down on the gel and F then becomes constant. In the case of a gelatin gel with 10% starch, the shape of the curve is similar, but Fₚₑₐₖ is lowered to 0.9 N. Next, for the gel with 20% starch, Fₚₑₐₖ is further lowered to 0.8 N (23% lower than for the bare gelatin). Such reduction of Fₚₑₐₖ signifies impact absorption by the gel, and we can directly attribute this effect to the presence of starch. The impact absorption is also reflected in another feature, which is that the second peak is nearly absent for the starch-bearing gels, indicating that the mass bounces less on these gels.

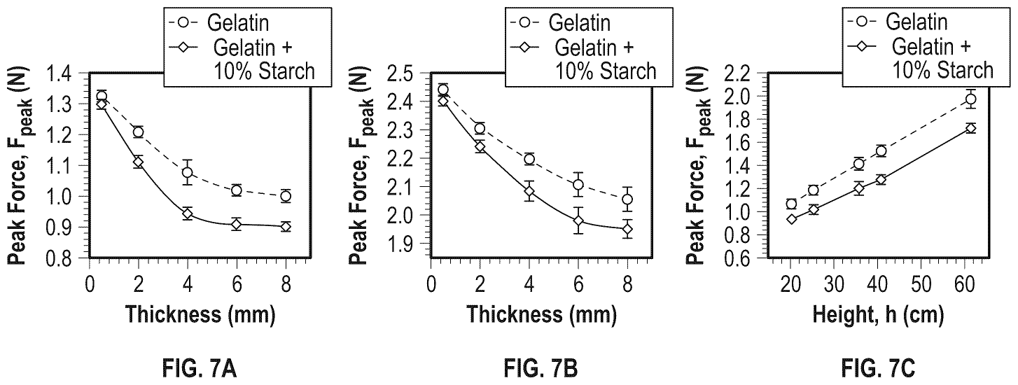

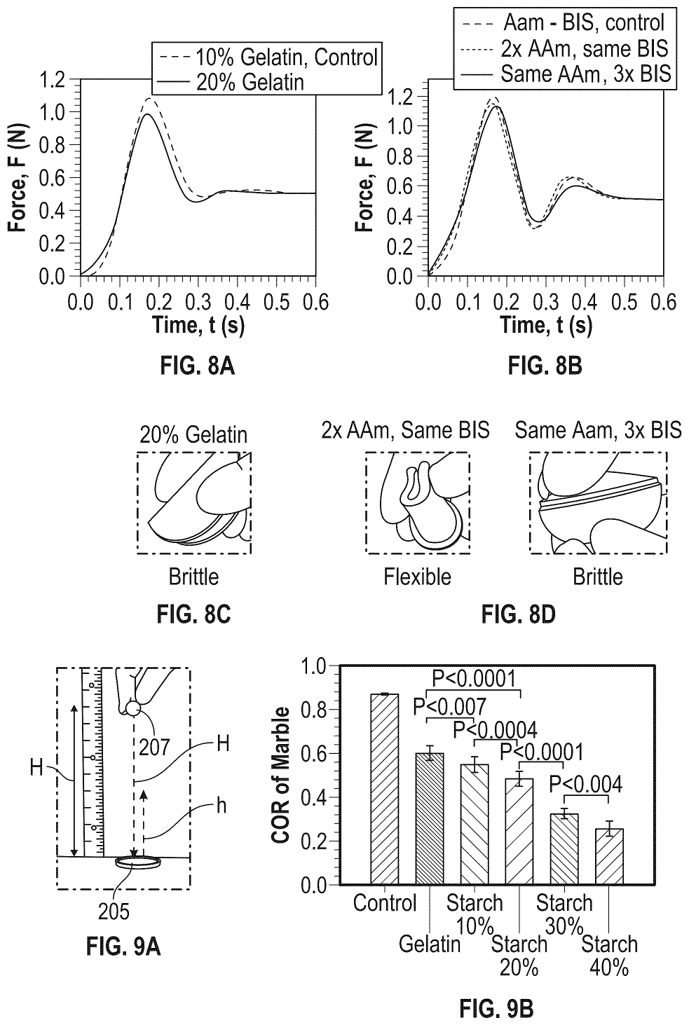

Impact absorption by starch-bearing gels is observed consistently in all experiments with the load-cell 200. The experimental details do influence the precise extent of reduction in the peak force Fₚₑₐₖ, and this is evidenced by the plots in FIGS. 7A-7C. The y-axis in all these plots is Fₚₑₐₖ. In FIGS. 7A-7B, we compare gels of different thicknesses. As the gel thickness is increased from 0.5 to 8 mm, Fₚₑₐₖ is reduced, and this is true for both bare gelatin gels as well as the same gels with 10% starch. Thus, a thicker gel, on its own, can absorb some of the impact. However, in all cases, the gels with starch show a lower Fₚₑₐₖ, indicating that they are surprisingly much more effective at absorbing impact. When the mass is increased from 50 to 100 g, as expected, Fₚₑₐₖ is roughly doubled (FIG. 7B), indicating a larger impact. But with this higher mass also, the starch-containing gels are able to reduce the impact substantially. In FIG. 7C, the same weight (50 g) is dropped from different heights onto gels of 4 mm thickness. As the height increases, the peak force also increases, indicating that the impact is larger, but we again note a reduction of 12 to 15% in Freak when the gel contains starch. For comparison, FIG. 8 shows F vs t curves for gelatin and AAm gels in the absence of starch. Varying the polymer concentration (gelatin in the former and AAm, BIS in the latter) does not appreciably affect the data. This proves the point that gels without starch are unable to absorb impact.

### Gelatin-Starch Gels: Coefficient of Restitution

Impact dissipation by gels can also be quantified by measuring the coefficient of restitution (COR). For these experiments, a 1 cm spherical glass marble is dropped from rest onto a surface (e.g., a gel) from a drop height H, and the bounce height h to which the marble bounces is measured (see FIG. 9A). The COR=\sqrt{h/H} is a measure of how elastic the collision is between the marble and the surface. If the marble is bounced on the hard tabletop, the COR is 0.86. The COR with various gels of 4 mm thickness was then tested. In the case of a 10% gelatin gel, the COR of the marble is reduced to 0.60 (FIG. 9B). Adding 10% starch to the gelatin gel reduces the COR to 0.54. With increasing concentration of starch, the COR continues to decrease and its value goes down to 0.26 for 40% starch. This reduction in COR with increasing starch in the gel is statistically significant (p<0.007 in all cases). The COR reduction again reflects the ability of starch-bearing gels to absorb or dissipate the impact of a collision. Note that the greater the starch content, the more the impact is absorbed: this is observed both with the peak force in FIG. 6 and the COR in FIGS. 9A-9B. Note that although we have gone up to 40% starch in the gels for the COR measurements, at these high concentrations, the starch granules do not get well-dispersed and remain as clumps in the gels. These inhomogeneous gels are also not flexible enough to wrap around brittle objects. Because of these constraints, the rest of the studies are mostly restricted to gels with starch of 20% or below.

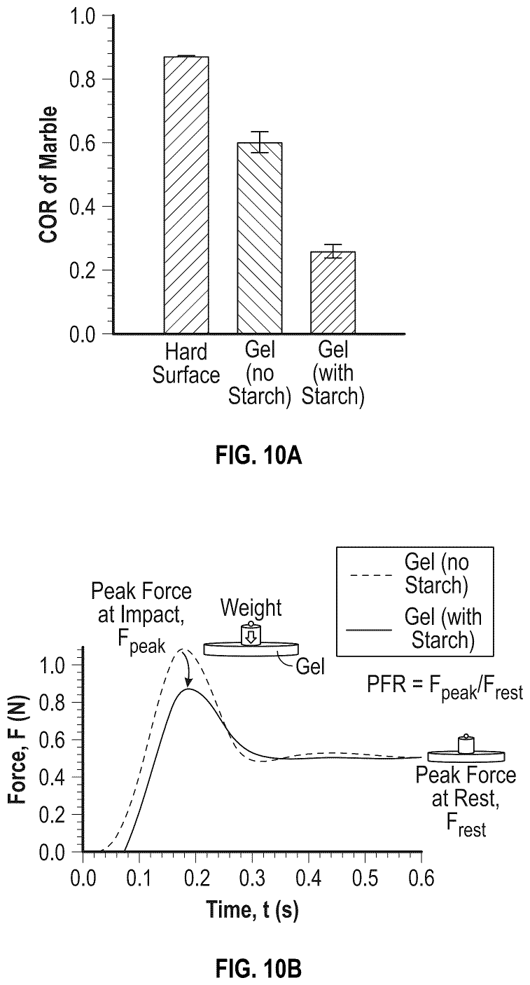

The COR for the marble is shown in FIG. 10A and the peak force ratio (PFR) for the marble is shown in FIG. 10B. Again, there is a lower COR which results in a higher impact absorption for the gel that includes starch. There is also a lower peak force ratio which results in a higher impact absorption for the gel that includes starch.

### Gelatin-Starch Gels: Rheology

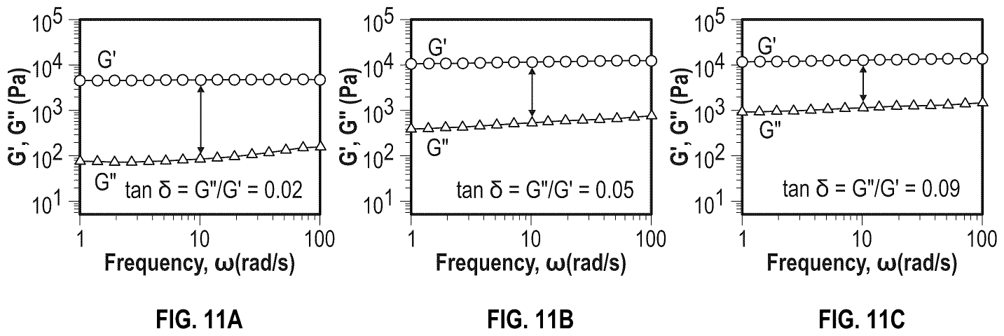

Starch enhances the impact-absorbing ability of gelatin gels. To gain insight into this aspect, the dynamic rheology of a 10% gelatin gel was measured without starch and with 10 or 20% starch. The data in FIGS. 11A-11C are for the clastic modulus G′ and the viscous modulus G″ as functions of the frequency ω. All samples show the expected rheology of gels, with G′ and G″ being independent of ω and G′>G″. Two trends are found in the data. First, the value of G′ (the gel modulus) is slightly higher in the presence of starch, indicating that the starch granules make the gel stiffer. Second, the gap between G′ and G″ narrows on adding starch (see arrows in FIGS. 11A-11C). In turn, the loss tangent tan δ=G″/G′ increases from 0.02 for the bare gelatin gel to 0.05 when 10% starch is present to 0.09 for 20% starch. The higher tan δ evidences there is far more viscous dissipation from the gel containing starch.

### AAm-Starch Gels

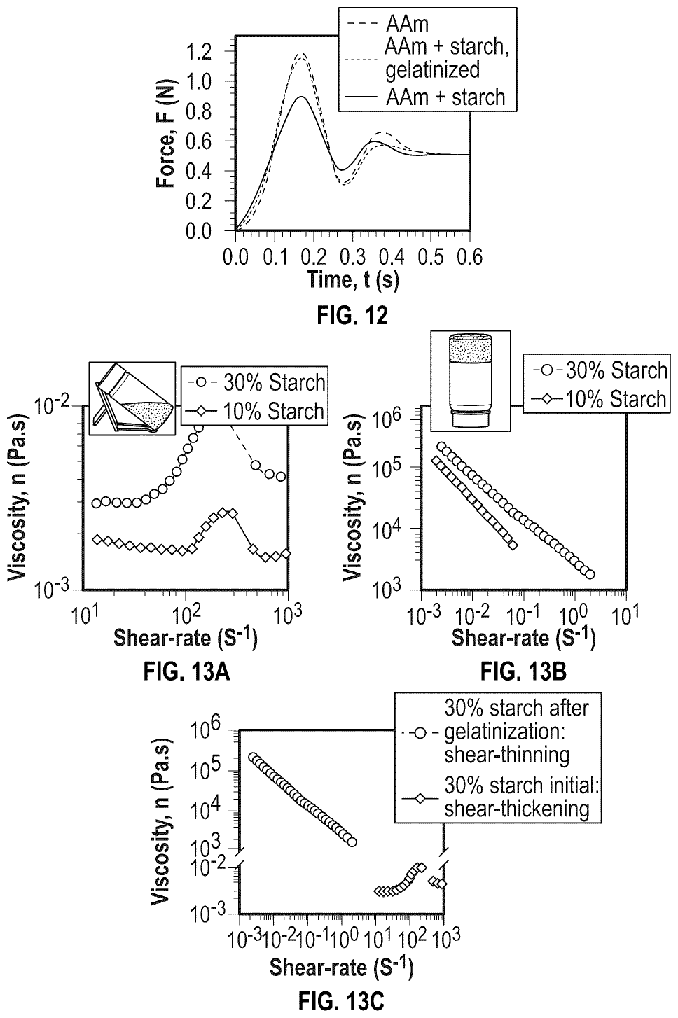

It was also tested whether the addition of starch granules influences the properties of a chemical gel, specifically that of AAm-LAP. As noted in FIGS. 2A-2C, a gel of 10% AAm cross-linked by 2% LAP is flexible and robust, and this gel was used as the control. For comparison, the same gel was made with 10% starch granules. The two gels (each 4 mm thick) were tested using the load cell, with a weight of 50 g dropped onto the gels from a height of 20 cm. The results (FIG. 12) are similar to those for the gelatin gels: the peak force Fₚₑₐₖ is reduced from 1.2 N for the AAm-LAP gel to 0.9 N for the same gel with starch. Thus, the effect of starch in absorbing impact is also seen with the chemical gels of AAm, much like with the physical gels of gelatin.

Starch granules when suspended in water make the fluid undergo shear-thickening, i.e., the viscosity of the suspension increases over a range of shear rates. This is shown for suspensions of 10 and 30% starch in water in FIG. 13A: note that the viscosity increases by a factor of 3 between shear rates of 25 and 200 s 1 for the 30% starch suspension and by a factor of 2 between 100 and 200 s 1 for the 10% starch suspension. Shear-thickening of a flowing suspension of particles is attributed to the creation of transient hydrodynamic clusters (“hydroclusters”) by the jamming of particles. This flow-induced clustering leads to an increase in viscosity. When the shear is ceased, the transient clusters dissipate away into individual particles and the viscosity reverts to a low value.

Shear-thickening can be related to impact absorption. Shear-thickening fluids (STFs) in particular can be introduced into fabrics such as Kevlar and enhance the fabric's resistance to stabbing with knives or other sharp objects. Foams and elastomers have contained STFs in the context of impact absorption, however no foam or elastomer systems were hydrogels and no foam or elastomer containing STFs used starch suspensions for shear-thickening. When particles such as starch are in a gel matrix, they will be immobilized and unable to flow. Thus, the gel cannot exhibit shear-thickening, unlike a flowing suspension. If so, impact absorption by a starch-bearing gel is unrelated to shear-thickening of the corresponding starch suspension.

In this regard, the AAm-starch gels allow an elegant way to test the role of shear-thickening. Shear-thickening is eliminated if the starch granules are gelatinized by heat. For example, when suspensions of starch in water are heated to 70° C., the granules will be partly dissolved, and the sample will no longer be a suspension of particles. The sample will then have starch chains in water and this will continue to be the case when cooled to 25° C. (i.e., gelatinization is irreversible). The images at the top of FIGS. 13A-13B show that a 30% starch sample is converted from a flowing suspension (FIG. 13A) to a paste with a yield stress (FIG. 13B). When this paste is sheared, the paste exhibits shear-thinning (e.g., a decrease in viscosity with increasing shear-rate, as shown by FIG. 13B).

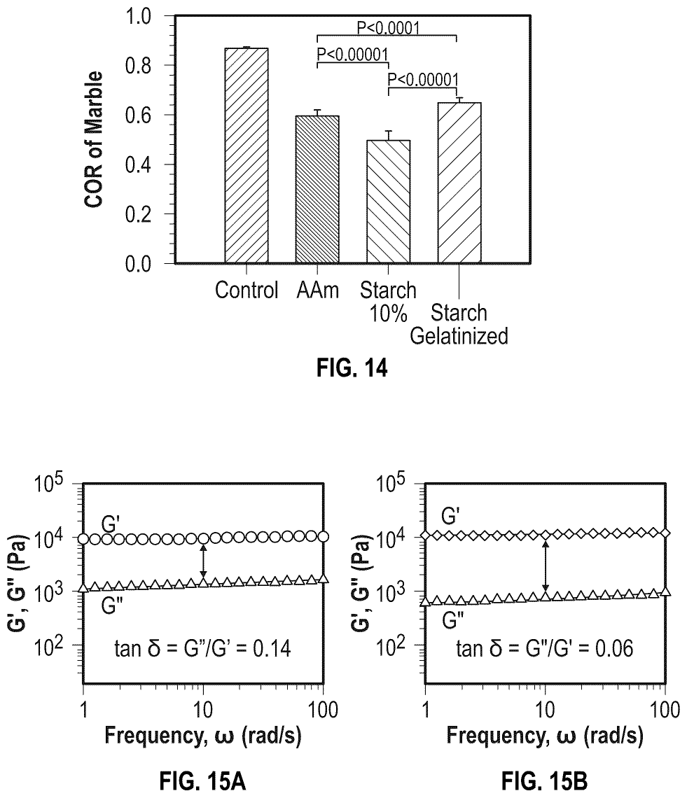

The gelatinization of starch can be done even when the granules are embedded in a gel. Thus, when an AAm-starch gel is heated to 70° C., the gel stays intact, but the starch granules will be gelatinized. Following the heating regimen, we cool the gel to room temperature and repeat the load-cell experiment (the cooled gel looks identical to the eye compared to its original state). Interestingly, however, the results in FIG. 12 show that the peak force Fₚₑₐₖ is increased back to 1.2 N, similar to its value for the control AAm gel without starch. Thus, the impact-absorbing effect of starch (reduction of Fₚₑₐₖ) is observed only when the starch granules are intact. When the granules get gelatinized, the starch loses its shear-thickening property, and in turn, the gel also loses its impact-absorbing property. This can be seen from their COR values as well (FIG. 14): the COR is 0.60 for the AAm gel and decreases to 0.50 when there is 10% starch, but when the starch is gelatinized, it rises back to 0.65. Note that the above experiments could not be done with gelatin-starch gels because gelatin gels are converted to sols upon heating.

To summarize, impact absorption by starch-bearing gels does go hand-in-hand with the shear-thickening of starch granules in water. This is a significant correlation, which evidences that shear-thickening and impact absorption can occur by a common mechanism. Note that the starch granules are 10 to 30 μm in size, whereas the pore (mesh) sizes of our gelatin and AAm gels are expected to be around 10-25 nm. See e.g., the following publications which name a present inventor, Thompson, B. R. et al., “Liposomes Entrapped in Biopolymer Hydrogels Can Spontaneously Release into the External Solution.” Langmuir 2020, 36, 7268-7276; and Subraveti, S. N. et al. “A Simple Way to Synthesize a Protective “Skin” around Any Hydrogel” ACS Appl. Mater. Interfaces 2021, 13, 37645-37654. Both of these publications are hereby incorporated by reference in their entireties herein. Thus, starch granules can be immobilized in the gels and will not be able to flow. There is unlikely to be any shear-thickening of the starch inside the gel.

It is possible that the granules undergo transient “jamming” at the moment that a load makes impact with the gel. Higher viscous dissipation from the gel is found in the presence of starch (higher tan δ). This can be beneficial for impact absorption. Incidentally, when the AAm-starch gel is tested after the starch is gelatinized, the tan δ is found to have decreased from 0.14 to 0.06 (FIGS. 15A-15B). Thus, gelatinization of starch also affects the gel's balance between clastic and viscous behavior.

### Testing if Gels Can Protect Fragile Objects

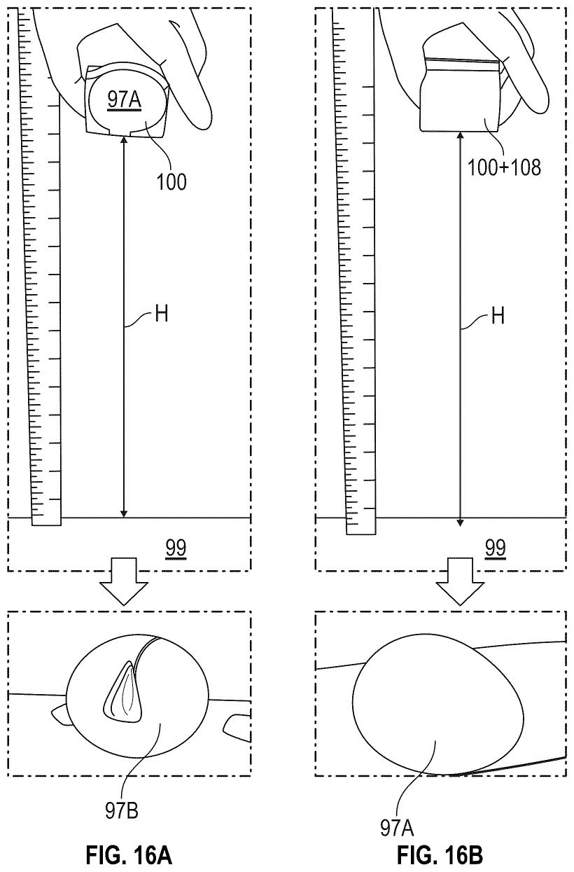

Finally, we put our gels to the test that we originally mentioned: to protect fragile objects. First, experiments were done with eggs. As shown in FIGS. 16A-16B, a standard chicken egg was wrapped with a rectangular strip of gel (dimensions of 17 cm×6 cm×4 mm) and then dropped in free fall from a height of 40 cm (˜15 in). (Note that, for consistency, the egg was always oriented with its pointy end parallel to the ground.) When a 10% gelatin gel is used (FIG. 16A), the egg is broken upon impact. However, when a gel of 10% gelatin+10% starch is used (FIG. 16B), the egg survives the impact and remains intact. This experiment was repeated from the same height with more than 10 eggs and the same above result was obtained in every case.

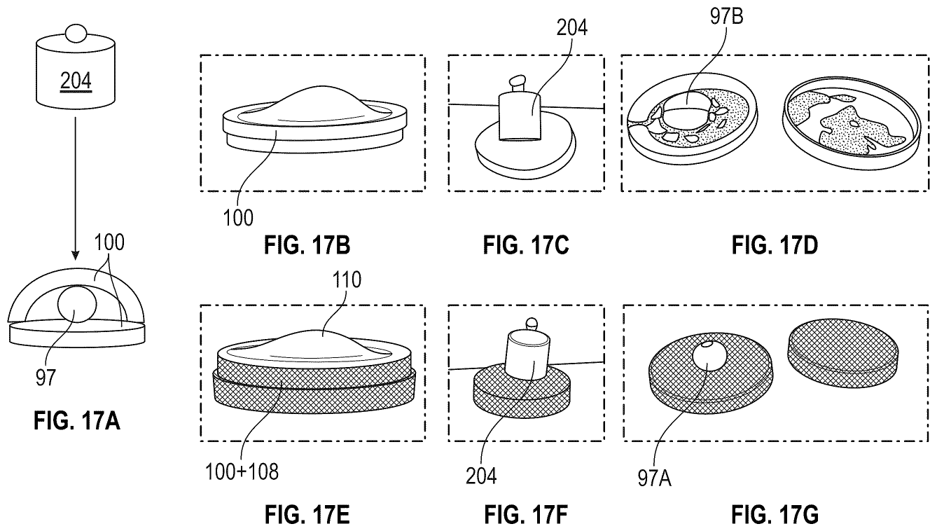

Next, a different set of experiments were conducted with small, delicate objects, i.e., fruit like mini tomatoes and blueberries. In this case, we wrapped the fruit with gels in a manner similar to ravioli, using two gel layers, each a disc of 6 cm diameter and 4 mm thickness (FIGS. 17A-17G). The fruit was placed on the first gel layer, then the second layer was placed on top and the ends were sealed by pressing both layers to form contact adhesion (see the schematic in FIG. 17A). A mass of 50 g was then dropped on the gel-covered fruit from a height of 20 cm (˜8 in) (see FIGS. 17A, 17B, and 17E). FIGS. 17E-17G show results with blueberries using this “ravioli” design. When the gel is 10% gelatin (control), the blueberry gets crushed by the impact (FIG. 17D). However, when a gel of 10% gelatin+10% starch is used, the blueberry remains intact (FIG. 17G). Collectively, FIGS. 16A-16B and 17A-17G collectively demonstrate that gels with starch are able to protect different kinds of fragile objects. Lastly, the corn starch in these studies was substituted with a potato starch. Granules of potato starch also confer protective abilities to gelatin gels. This confirms that starch (regardless of the source) is the key for these remarkable protective properties, and so it is therefore to be appreciated that rice starch, cassava starch, and other suitable starches can be used.

### Gelatin-Starch Dry Films Absorb Impact Similar to Gelatin-Starch Wet Gels

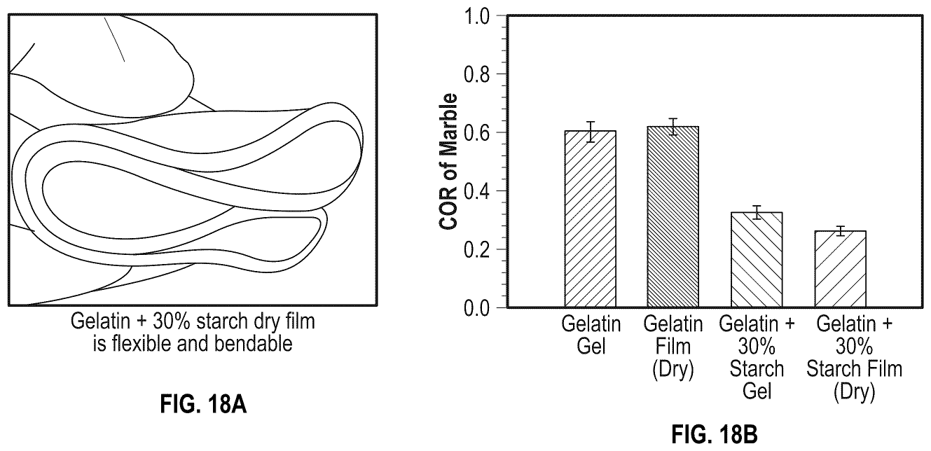

Films were prepared as follows. First, 10% gelatin, 30% starch, and 30% glycerol were combined and added to water and mixed at 50° C. until homogeneous. The sample was poured into a Petri dish and cooled to room temperature to form a hydrogel. This gel was allowed to dry under ambient conditions for 24 h to give a dry film. During the drying process, the weight of the sample reduced by ˜ 30% as the water evaporated. Glycerol was added because it is a plasticizer, i.e., a non-volatile molecule that persists even when the sample is dried. If no glycerol was used, the gel became a brittle solid upon drying. With glycerol, the dry film remained flexible and bendable, as shown in FIG. 18A.

The coefficient of restitution (COR) is one measure of impact-absorption. The lower the COR, the higher the extent of impact that is absorbed. FIG. 1B shows that the COR of a marble is lowered by the presence of starch for dry and wet samples. In the case of the gels (which are wet, i.e., contain water), the COR is lowered from 0.60 for the gelatin gel alone to 0.32 for the gel with 30% starch. In the case of the dry films, the COR is lowered from 0.61 for the film with gelatin alone to 0.26 for the film with both gelatin and 30% starch. Thus, both the dry films as well as the wet gels absorb more impact, as indicated by their lower COR, when they contain starch.

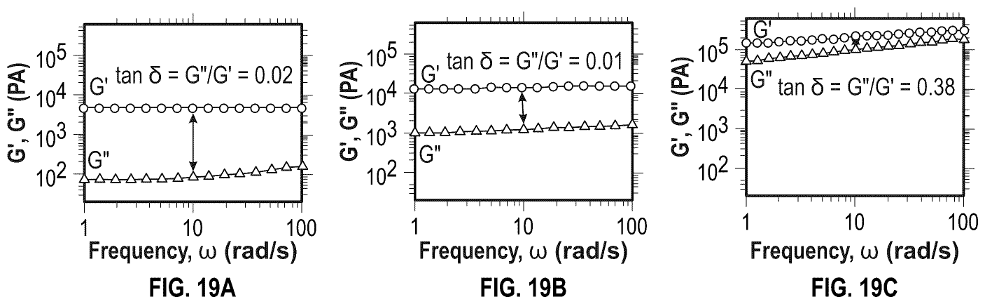

A second measure of impact-absorption is the loss tangent tan δ from dynamic rheology, which is the ratio of the viscous modulus G″ to the elastic modulus G′. The higher this parameter, the greater the extent of impact-absorption. FIG. 19A shows data for a gel of gelatin alone, for which tan δ at 10 rad/s is 0.02. For a wet gel of gelatin+30% starch, tan δ increases to 0.1, as shown in FIG. 19B. For a dry film of gelatin+30% starch, plasticized by glycerol (same as in FIG. 18A), tan δ increases further to 0.38, as shown in FIG. 19C. Thus, by this measure, the dry film is by far the best at absorbing impact.

### Hysteresis Loop

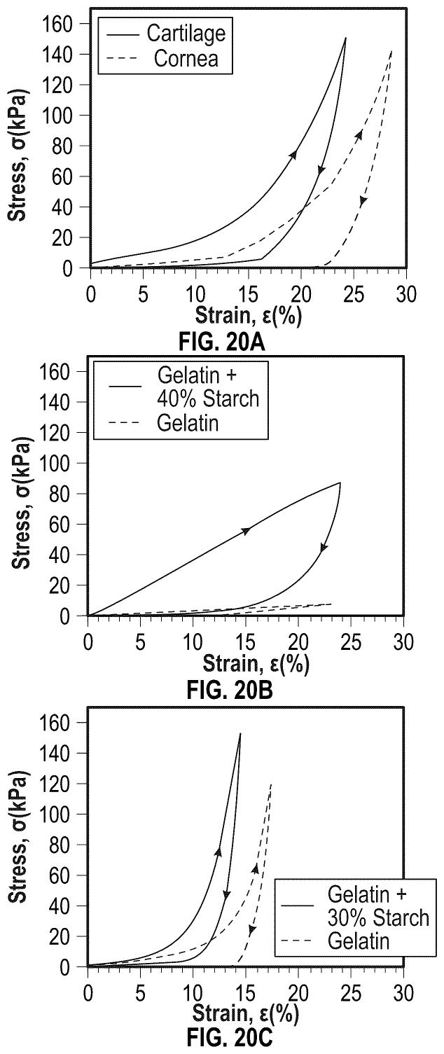

A third measure of impact-absorption is obtained from cyclic tests of uniaxial compression. When a sample is compressed and then the stress is relaxed, some materials show a ‘hysteresis loop’: the stress-strain curve during compression deviates from the curve during relaxation, as shown in FIGS. 20A-20C. If so, the loading and unloading curves together form a ‘hysteresis loop’ and the area enclosed by such a loop is believed to indicate the ability of the material to absorb impact.

Consistent with this idea, biological tissues and gelatin-starch samples were examined under compression. The tests were conducted on an AR2000 rheometer at 25° C. using a parallel plate (20 mm in diameter) in the squeeze-test mode. Sample discs were placed at the center of the plates. Compression was performed at a rate of 10% strain per minute, followed by retraction at the same rate. The normal-stress transducer was used to collect the normal force, which was converted to stress based on the initial surface area of the gel. The transducer had an upper limit of 50 N and compression was stopped when the measured force reached this limit.

FIG. 20A shows that biological tissues do have large loop areas, indicating their excellent ability to absorb impact. Specifically, this area is 5.3 kJ/m³ for bovine cornea and 5.7 kJ/m³ for bovine cartilage. FIG. 20B shows data for gels. The gelatin gel (control) has a negligible loop. In contrast, the gel with gelatin+40% starch shows a loop area of 5.8 kJ/m³. Next, FIG. 20C shows data for dry films. The dry gelatin film without starch does show a hysteresis loop, the area of which is 4.0 kJ/m³. But the dry film with gelatin+30% starch (same as in FIG. 18A) has the highest loop area, which is 8.0 kJ/m³. These results imply that dry gelatin-starch films could be superior to biological tissues in their ability to absorb impact.

### Industrial Applications

The present disclosure shows there is a class of hydrogels that is (a) flexible and robust and (b) able to enclose fragile objects and protect them against impact. This combination of properties works with at least two classes of gels, one based on gelatin (physical gels) and the other on AAm (chemical gels). The key ingredient that allows both types of gels to absorb impact is starch. Flexible gels with dispersed starch granules can be wrapped around fragile objects like eggs or fruit and subsequently shield these objects from impact, either when the object is dropped onto a hard surface or if a weight is dropped on the object.

Hydrogels have not previously been studied for their ability to absorb impact. All conventional gels, regardless of their mode of cross-linking (physical vs chemical), cross-link density, or polymer concentration, were poor at absorbing impact. Even double-network gels, which are very strong and stretchable, fail to absorb impact. Starch remedies these shortcomings by improving the ability of gels to absorb impact, and the higher the starch content, the greater the effect.

Impact absorption is quantified by the reduction in the peak force Fₚₑₐₖ when a load strikes the gel. Impact force is also seen as a reduction in the COR when a hard object (a marble) is bounced on the gel. The rheological signature of impact-absorbing (starch-bearing) gels seems to be a higher extent of viscous dissipation, which correlates with a higher value of the loss tangent tan δ.

The mechanism(s) by which starch enhances the gels' ability to absorb impact is (1) the correlation with starch's ability to shear-thicken water; and (2) when starch granules are gelatinized by heat, they no longer give rise to shear-thickening. That is, unlike any other type of shear-thickening fluid, the shear-thickening of starch suspensions can be turned off by heat. Correspondingly, a gel with gelatinized starch loses its impact-absorbing properties. This is an important correlation, and the correlation suggests that shear-thickening and impact absorption may have a common origin. The addition of starch is shown to increase tan δ, and this increase in viscous dissipation may underlie the effects of starch in absorbing impact.

The protective abilities conferred by starch in hydrogels are generalizable and apply widely to many different gels. Starch granules are readily available, inexpensive, and eco-friendly, because they are derived from natural sources, biocompatible, and biodegradable. Thus, their use to protect fragile objects is easily translated into practical systems.

From the foregoing, it can be seen that the present disclosure accomplishes at least all of the stated objectives.

### Experimental Section

### Materials

The monomers acrylamide (AAm), N,N′-dimethyl-acrylamide (DMAA), and N,N′-methylene-bis(acrylamide) (BIS); the biopolymers gelatin (from porcine skin, type-A), agarose (Type 1-A, low EEO, melting temperature ˜88° C.), and alginate (alginic acid sodium salt from brown algae, medium viscosity); the initiator ammonium persulfate (APS); the accelerant N,N,N′,N′-tetramethyl-ethylene-diamine (TEMED); and calcium chloride dihydrate salt were all purchased from Sigma-Aldrich. The inorganic clay Laponite XLG (LAP) was obtained from Southern Clay Products. Iron oxide (Fe₂O₃) particles (Yellow 3910) were purchased from LanXess Chemicals and carbon black particles (N110) were from Sid Richardson Carbon Company. Starch granules (from corn, product name HYLONVII) were purchased from Ingredion. The granules have an amylose content of 70% and their size range is 10-30 μm. Potato starch granules (size range 10-50 μm) were purchased from Sigma-Aldrich.

### Preparation of Gels

To prepare gelatin gels, gelatin powder was mixed vigorously with deionized (DI) water using a stir bar at a temperature of 60° C. The resulting sample was poured into a container (Petri dish or vial) and cooled to room temperature to form the gel. Gelatin gels with particulate additives (starch granules, Fe₂O₃, or CB) were prepared the above way with the particles included along with the gelatin powder in the initial step. Typical concentrations in weight percent were 10% gelatin and 10% starch (or 5% Fe₂O₃ or 10% CB) unless otherwise specified. To make gels of different thicknesses, different volumes of the ungelled sample were poured into a Petri dish (the lower the volume, the thinner the final gel).

Physical gels of agarose were prepared in a similar manner to the gelatin gels. Agarose (5%) was added to DI water and mixed using a stir bar at a temperature above 85° C. until the agarose completely dissolved. The resulting solution was then poured into a mold. Upon cooling to room temperature, agarose gels were obtained.

To prepare chemical gels, a solution of the monomer AAm (10%, equivalent to 1 M) was made in DI water that had been degassed by bubbling nitrogen. For BIS-cross-linked gels, 0.34% BIS (equivalent to 2.2 mol % with respect to the monomer) was added to the AAm solution. The initiator APS (200 μL of a 0.1% solution) and the accelerator TEMED (30 μL) were then added and vortex-mixed. The gel was then allowed to polymerize at room temperature. For LAP-cross-linked gels, 2% of LAP particles were first suspended in DI water and mixed vigorously with a stir bar, and then 10% AAm and 0.05% BIS were added, followed by APS and TEMED as above. The mixture was then polymerized into a gel. Starch granules (typical concentration 10%) were added to the pregel mixture to make AAm gels with starch. For the double network gels, alginate was dissolved in DI water at a concentration of 1%. Next, AAm (10%) and BIS (0.006%) were added, followed by APS (1.5%) and TEMED (0.02%). The sample was mixed on a stir plate and allowed to polymerize for 24 h in a Petri dish. The formed gel was then incubated in a 2% CaCl₂) solution for 24 h to finally obtain the double network gel.

### Load Cell Tests

A HX711 module with an A/D converter chip was connected to a load cell (5 kg). The module and the load cell were purchased from Amazon. An impact plate (1 mm thick) was attached on top of the load cell, which was subsequently drilled onto a base plate (5 cm thick). The impact plate was 3D-printed using an Ender 3D printer using a black colored plastic filling, whereas the base plate was made of wood. The setup was then connected to a laptop through an Arduino USB cable, and the experiment was run using open-source Arduino software. The load cell was first calibrated using known weights ranging from 1 to 500 g. Next, gel strips (discs of 6 cm diameter and varying thickness) were placed on the impact plate and known weights were released from a height through a hollow plastic tube for precise control of the trajectory. Force vs time curves were obtained as the output on the laptop.

### Rheological Studies

All rheological experiments were done on an AR2000 rheometer (TA Instruments) at 25° C. using either a parallel plate geometry (20 mm diameter) or a cone-and-plate geometry (2° cone, 40 mm diameter). For the oscillatory shear (dynamic rheology) experiments, gel samples were cut into discs of 20 mm diameter and 3-4 mm thickness. Through stress-sweep experiments, the linear viscoelastic region of the samples was obtained, and a strain (1%) within this region was used to run the frequency-sweep experiments. Steady-shear rheology was done in stress-control mode for the starch suspensions and as shear-rate sweeps for the gelatinized pastes.

### Optical Microscopy

Bright-field images of 10% starch suspensions in water and of a 10% gelatin gel containing 10% starch were taken with a Zeiss Axiovert 135 TV inverted microscope using a 20× objective. The gel was cut into a very thin slice to be able to view the underlying structure under the microscope.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 97 | vulnerable object (e.g., egg, smartphone) |
| 97A | unbroken vulnerable object |
| 97B | broken vulnerable object |
| 98 | force causing an impact (e.g., Earth's gravitational force that pulls |
| | objects toward Earth's core) |
| 99 | hard surface (e.g., the ground or a tabletop) |
| 100 | soft impact-absorbing material (e.g. a hydrogel) |
| 101 | flexible physical gel (e.g., gelatin) |
| 102 | brittle physical gel (e.g., agarose) |
| 103 | brittle chemical gel (e.g., acrylamide (AAm) polymerized with bis- |
| | acrylamide (BIS) nanoparticles) |
| 104 | flexible chemical gel (e.g., acrylamide (AAm) polymerized with |
| | laponite (LAP) nanoparticles) |
| 105 | double-network gel (e.g. a gel having both a alginate-Ca²⁺ and an |
| | AAm-BIS network) |
| 106 | chains intertwined into triple helices |
| 107 | cross-linking junctions |
| 108 | starch granules (e.g. 10-30 μm) |
| 109 | flexible, bendable property |
| 110 | covering configuration |
| 200 | load cell |
| 201 | base plate |
| 202 | impact plate |
| 203 | load sensor |
| 204 | mass |
| 205 | gel sample |
| 206 | hollow transparent plastic tube |
| 207 | marble |
| h | bounce height |
| H | drop height |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

“Starch” or amylum is a polymeric carbohydrate consisting of numerous glucose units joined by glycosidic bonds. This polysaccharide is produced by most green plants for energy storage. Worldwide, it is the most common carbohydrate in human diets, and is contained in large amounts in staple foods such as wheat, potatoes, maize (corn), rice, and cassava (manioc).

Pure starch is a white, tasteless and odorless powder that is insoluble in cold water or alcohol. It consists of two types of molecules: the linear and helical “amylose” and the branched “amylopectin”.

“Hysteresis” is the dependence of the state of a system on its history. Hysteresis comprises effects that persist after the initial causes giving rise to the effects are removed. Industrial applications generally exhibit rate-dependent hysteresis, that is, they can be subject to dissipative effects like friction that will eventually cause the output to decay to zero. Thus, it is to be appreciated that “hysteresis”, as used herein, comprises both “rate-dependent” and “rate-independent” hysteresis.

Plots of a single component of the moment often form a “hysteresis loop” or “hysteresis curve,” where there are different values of one variable depending on the direction of change of another variable.

“Elastic hysteresis” is the difference between the strain energy required to generate a given stress in a material, and the material's elastic energy at that stress. This energy is dissipated as internal friction (heat) in a material during one cycle of testing (loading and unloading). Different materials experience differing degrees of elastic hysteresis.

What is claimed is:

1. A soft impact-absorbing material, comprising:
a flexible network of polymers;
shear-thickening granules that shear-thicken in the presence of a fluid.

2. The soft impact-absorbing material of claim 1, wherein the fluid is water.

3. The soft impact-absorbing material of claim 1, wherein the shear-thickening granules are starch granules.

4. The soft impact-absorbing material of claim 1, wherein the starch granules are derived from a crop selected of the group consisting of: wheat, potatoes, maize (corn), rice, and cassava (manioc).

5. The soft impact-absorbing material of claim 1, wherein the flexible network of polymers comprises gelatin.

6. The soft impact-absorbing material of claim 1, wherein the flexible network of polymers comprises acrylamide (AAm) polymerized with laponite (LAP) nanoparticles.

7. The soft impact-absorbing material of claim 1, wherein the flexible network of polymers comprises a gel having both a alginate-Ca²⁺ and an AAm-BIS network.

8. The soft impact-absorbing material of claim 1, wherein the flexible network of polymers comprises chains intertwined into triple helices.

9. The soft impact-absorbing material of claim 1, wherein the flexible network of polymers comprises cross-linking junctions.

10. The soft impact-absorbing material of claim 1, further comprising glycerol.

11. The soft impact-absorbing material of claim 1, further comprising air bubbles.

12. The soft impact-absorbing material of claim 1, wherein the soft impact-absorbing material comprises an elastic rheology having a loss tangent (8) of at least 0.05.

13. The soft impact-absorbing material of claim 1, wherein the soft impact-absorbing material is dehydrated.

14. The soft impact-absorbing material of claim 1, wherein the soft impact-absorbing material exhibits a hysteresis loop of at least 5.8 kJ/m³.

15. A load cell for testing hydrogels comprising:
a base plate;
an impact plate supported by the base plate;
a gel sample loaded onto the impact plate;
a load sensor operatively connected to the impact plate and capable of measuring a force applied to the gel sample; and
a hollow transparent plastic tube for guiding a mass onto said gel sample or said impact plate.

16. The load cell of claim 15, further comprising wherein the gel sample comprises:
a flexible network of polymers; and
starch granules.

17. The load cell of claim 15, wherein the load cell includes the mass, and the mass is a marble.

18. The load cell of claim 17, further comprising a visual sensor for calculating a coefficient of restitution (COR) based on a bounce height at which the mass bounces of said sample in relation to a drop height from which the mass was dropped.

19. The load cell of claim 15, further comprising sample discs placed at the center of plates for compressing the gel sample.

20. The load cell of claim 15, further comprising a normal-stress transducer to collect a normal force, convertible to stress based on the initial surface area of the gel sample.
